(19) United States
(12) Patent Application Publication
(10) Pub. No.: US 2026/0155473 A1
(43) Pub. Date: Jun. 4, 2026

(54) TRACTION BATTERY FOR A MOTOR VEHICLE

(71) Applicant: AUDI AG, Ingolstadt (DE)

(72) Inventors: Carsten LORENZ, Reichertshofen (DE); Eduard MAIN, Buxheim (DE)

(73) Assignee: AUDI AG, Ingolstadt (DE)

(21) Appl. No.: 19/380,063

(22) Filed: Nov. 5, 2025

(30) Foreign Application Priority Data
Nov. 29, 2024 (DE) 102024135437.2

(51) Int. Cl. H01M 10/613; H01M 10/625; H01M 10/6551; H01M 10/6556; H01M 50/264

(52) U.S. Cl. CPC H01M 10/613; H01M 10/625; H01M 10/6551; H01M 10/6556; H01M 50/264

(57) ABSTRACT

A traction battery for a motor vehicle, with a cell module including a battery cell arrangement and a temperature control device for controlling the temperature of the battery cell arrangement. A cell connector is arranged between each pair of battery cells of the battery cell assembly, which connector is connected to connection terminals of the battery cells in order to establish an electrical connection between the battery cells. The temperature control device includes a temperature control element with at least one fluid channel and a temperature control surface to which the battery cells are in heat-transferring contact. A heat transfer projection extends from the temperature control element between the battery cells and is in heat-transferring contact with the cell connector.

### FIELD

The invention relates to a traction battery for a motor vehicle, comprising a cell module having a battery cell arrangement and a temperature control device for temperature control of the battery cell arrangement, wherein a cell connector is arranged between each two battery cells of the battery cell arrangement, which cell connector is connected to connection terminals of the battery cells to establish an electrical connection between the battery cells.

### BACKGROUND

Document DE 10 2016 116 581 A1 is known from the prior art, for example. This describes a connecting plate for connecting battery cells for a battery, wherein the connecting plate has contact points on a front side and a back side and wherein each contact point is designed to make electrically and thermally conductive contact with a battery cell, so that a plurality of battery cells can be thermally and electrically conductively connected to one another via the connecting plate, wherein at least one heat dissipation element is provided in the connecting plate for dissipating heat from the connecting plate. The heat dissipation element is designed as a cooling channel through which a coolant can flow. Alternatively, the heat dissipation element is designed as a thermally conductive core layer. At least one cooling channel through which the coolant can flow can be provided in the core layer.

Furthermore, DE 10 2019 217 766 A1 discloses a high-voltage battery for an electrically powered vehicle, having at least one battery module in the module housing of which a plurality of cylindrical round battery cells are arranged, which are stacked coaxially in series with end faces facing one another. It is provided that at least one intermediate wall is provided in the module housing, which wall is arranged between mutually facing end faces of the round battery cells, and that the intermediate wall is flowed through by coolant as a component of a battery cooling system.

DE 10 2011 001 371 A1 also discloses a motor vehicle with a battery comprising a housing with battery cells and a temperature control/cooling system. In order to further improve the crash behavior of a motor vehicle with a battery, the supply and/or discharge lines of the temperature control/cooling system are designed as fluid-carrying impact pipes.

### SUMMARY

It is an object of the invention to propose a traction battery for a motor vehicle which has advantages over known traction batteries, in particular enabling effective temperature control of the battery cell arrangement of the cell module even with a high energy storage density of the traction battery.

This is achieved according to the invention with a traction battery for a motor vehicle. It is provided that the temperature control device has a temperature control element having at least one fluid channel with a temperature control surface against which the battery cells rest in a heat-transferring manner, wherein a heat transfer projection extends from the temperature control element, which projection extends between the battery cells and rests against the cell connector in a heat-transferring manner.

Advantageous embodiments with expedient developments of the invention are specified in the disclosure. It is pointed out that the embodiments explained in the description are not limiting; rather, any variations of the features disclosed in the description, the claims and the figures can be implemented.

The traction battery is preferably part of the motor vehicle, but can of course also be present separately from it, in particular before the traction battery is fitted on or in the motor vehicle. The traction battery is intended and designed for the temporary storage of electrical energy for a drive device of the motor vehicle. The drive device is used to drive the motor vehicle and thus to provide a drive torque that is for driving the motor vehicle. To provide the drive torque, the drive device has at least one drive unit which is designed as an electric traction machine that is electrically connected to the traction battery.

The electrical energy temporarily stored in the traction battery is thus used to drive at least temporarily the motor vehicle, thus to provide the drive torque intended to drive the motor vehicle by means of the drive device or the drive unit. Conversely, it can be provided that electrical energy provided by the drive device is temporarily stored in the traction battery.

The traction battery has the battery cell arrangement, which in turn has multiple battery cells. The battery cells are preferably prismatic cells or a pouch cells. The battery cell arrangement together with the temperature control device forms the cell module of the traction battery. The cell module is, for example, a component of a battery module of the traction battery, which in addition to the cell module preferably has end plates and/or a clamping device. The battery module can have one or more cell modules. In particular, the cell modules of the battery module are designed identically, so that the statements in this description for the cell module are applicable to each of the plurality of cell modules of the battery module. The cell module or the plurality of cell modules are arranged between the end plates and clamped by means of the clamping device to thus form the battery module.

The end plates are, for example, part of a battery module housing. The end plates accommodate the cell module or the cell modules, in particular the battery cell arrangement or the battery cell arrangements of the cell modules, between them. In this respect, the end plates are arranged on opposite sides of the cell module or cell modules. Preferably, the battery cell arrangement is cuboid-shaped or at least approximately cuboid-shaped.

The multiple battery cells of the battery cell arrangement are electrically interconnected. For this purpose, the battery cells are arranged, for example, in such a way that their electrical connections, which are also called connection terminals, are arranged on the same side and/or face each other. The connection terminals of the battery cells are electrically connected to each other via the cell connector. More precisely, such a cell connector is arranged between each two of the battery cells, which cell connector electrically connects the connection terminals of these two battery cells.

At the end of the battery cell arrangement, the cell modules preferably have additional connection terminals. These end connection terminals are electrically connected to busbars, which are preferably also electrically connected to electrical connections of the cell module and/or the battery module. For example, the battery module has multiple cell modules. In this case, the additional connection terminals of the multiple cell modules are electrically connected to each other via the busbar and are also electrically connected to the connection terminals of the battery module. In other words, the battery cells of the cell module are electrically connected to the terminals, in particular of the cell module and/or battery module, via the busbars.

Preferably, the traction battery has a battery housing in which a battery module receptacle is configured, which is provided and configured to receive the battery module or a plurality of battery modules. During the production of the traction battery, the battery module is inserted into the battery module receptacle. Preferably, not only a single battery module is arranged in the battery housing, but rather multiple battery modules are introduced into the battery housing. In such an embodiment, the battery housing has a battery module receptacle which is designed to accommodate multiple battery modules, or multiple battery module receptacles.

During operation of the traction battery, heat is generated in the battery cell arrangement, which must be dissipated from it, or heat must be supplied to reach a certain temperature of the battery cell arrangement. Accordingly, the traction battery or cell module has the temperature control device by means of which the temperature of the battery cell arrangement is at least temporarily controlled. With the aid of the temperature control device, heat is at least temporarily dissipated from the battery cell arrangement and/or heat is supplied to the battery cell arrangement using the temperature control device.

The temperature control device is usually part of the battery housing, in particular a base plate of the battery housing. During assembly of the traction battery, the cell module is inserted into the battery housing in such a way that the battery cell arrangement is subsequently connected to the temperature control device or the base plate in a heat-transfer manner. To ensure a reliable connection of the battery cell arrangement to the temperature control device, a heat transfer medium can be used. This is sometimes also referred to as a “gap filler”. However, such a design of the traction battery only allows the heat to be dissipated or supplied over a comparatively small region of the battery cell arrangement. Accordingly, achieving a uniform temperature distribution in the battery cell arrangement is challenging.

For this reason, the invention provides that the temperature control device has the temperature control element. At least one fluid channel is formed in the temperature control element, through which channel a fluid flows at least temporarily for temperature control of the battery cell arrangement. In other words, the fluid is supplied to the fluid channel on the one hand and removed on the other hand from the fluid channel at least temporarily for temperature control of the battery cell arrangement. In particular, the fluid channel is fluidically connected to a fluid circuit.

The temperature control element is in particular different from the base plate of the battery housing; preferably, it is arranged at a distance from the base plate and/or at an angle to the base plate. When using the temperature control element, it is not necessary to design the base plate for temperature control of the battery cell arrangement. The base plate can therefore be designed without fluid channels. Of course, it is also possible to create a fluid channel in the base plate through which the fluid flows, at least temporarily.

Of course, also one single fluid channel can be created in the temperature control element. Preferably, however, there are multiple fluid channels in the temperature control element, which are preferably fluidically connected in parallel. The fluid flows through the multiple fluid channels simultaneously or in parallel. If in the context of this description the at least one fluid channel or the fluid channel is mentioned, the statements are always equivalent. Explanations regarding the at least one fluid channel are therefore transferable to the fluid channel and statements regarding the fluid channel are transferable to the at least one fluid channel. If there are multiple fluid channels, the explanations regarding the at least one fluid channel or the fluid channel can preferably be transferred to each of the multiple fluid channels.

The temperature control element is preferably mechanically connected to the battery cell arrangement, for example by using a holding frame. The holding frame thus connects the temperature control element and the battery cell arrangement to each other; for this purpose, it engages the temperature control element on the one hand and the battery cell arrangement on the other in a holding manner. The battery cell arrangement, the temperature control device or the temperature control element and the holding frame together form the cell module. This is inserted into the battery housing, in particular as a component of the battery module. During assembly of the traction battery, the entire cell module is preferably inserted into the battery housing, i.e. the battery cell arrangement, the temperature control device or the temperature control element and the holding frame connecting them are inserted together into the battery housing, so that a modular structure of the traction battery is provided.

Over time, the battery cell arrangement may expand, particularly during charging or discharging of the traction battery. This expansion can also be called “swelling”. To counteract this expansion, the battery cell arrangement is usually mechanically clamped. For this purpose, the battery cell arrangement is subjected to a clamping force using the clamping device, by which the battery cell arrangement is subjected to a contact pressure that counteracts the expansion. The clamping force counteracts an expansion force exerted on the clamping device by the expansion of the battery cell arrangement. To clamp the battery cell arrangement, the clamping device engages the end plates located on opposite sides of the battery cell arrangement and exerts the clamping force on them. The end plates are therefore pushed towards each other by the clamping force, and the battery cell arrangement is subjected to the clamping force by the clamping device via the end plates.

The clamping device comprises, for example, a metal band which is arranged around the battery cell arrangement in the open state and is subsequently closed and then tensioned in order to effect the clamping force. It can also be provided that the clamping device has a circumferentially closed clamping band, which is arranged around the battery cell arrangement in the circumferentially closed state. In particular, for this purpose, the battery cell arrangement is compressed and thereby tensioned by applying a pre-tensioning force, the circumferentially closed tensioning band is arranged around the battery cell arrangement and subsequently the pre-tensioning of the battery cell arrangement with the pre-tensioning force is terminated.

The temperature control element has the temperature control surface for temperature control of the battery cell arrangement or the battery cells. The temperature control surface is understood to be a surface of the temperature control element facing the battery cells, against which the battery cells rest in a heat-transferring manner, preferably flatly. The expansion of the battery cell arrangement and the resulting dimensional change of the battery cell arrangement caused by this expansion can lead to a deterioration of the heat transfer between the battery cell arrangement and the temperature control element or temperature control surface.

In order to achieve a particularly reliable thermal connection between the temperature control element to the battery cell arrangement, the heat transfer medium is therefore inserted between the temperature control element and the battery cell arrangement. The temperature control element is thermally coupled to the battery cell arrangement via the heat transfer medium; for this purpose, the heat transfer medium is accommodated between the temperature control element and the battery cell arrangement and lies on the one hand against the temperature control element and on the other hand against the battery cell arrangement, in particular in a flat manner. With the help of the heat transfer medium, the thermal connection between the battery cell arrangement and the temperature control element can be maintained and thus ensured even in the event of significant dimensional changes in the battery cell arrangement.

An additional heat source in the traction battery is the cell connector or multiple cell connectors. The cell connector(s) have an electrical resistance, which can also be referred to as internal resistance. During operation of the traction battery, in particular during discharging or charging of the traction battery, electrical current flows between the battery cells through the cell connector. Due to the internal resistance of the cell connector, this causes the conversion of electrical energy into heat, so that the temperature of the cell connector increases. Since the cell connector is connected to the connection terminals of the battery cells, the heat is transferred to the battery cells by conduction and/or heat transfer, so that they also heat up in their end regions. This causes an inhomogeneity of the temperature distribution in the battery cells, which in turn causes different aging behavior within the battery cells. In particular, warmer regions of the battery cells age faster than cooler regions. This applies especially to NMC and NCA battery cells.

For this reason, it is provided to connect not only the battery cell thermally or in a heat-transferring manner with the temperature control element, but also the cell connector. For this purpose, the heat transfer projection extends from the temperature control element. The heat transfer projection is therefore on the one hand in contact with the temperature control element and/or is fastened to the temperature control element. Starting from the temperature control element, the heat transfer projection extends between the battery cells so that it is present between the battery cells. For example, the heat transfer projection forms an angle with the temperature control element or the temperature control surface that is greater than 0° and less than 180°. Particularly preferably, the angle is at least 60° and at most 120°, at least 75° and at most 105° or approximately or exactly 90°.

The heat transfer projection that engages between the battery cells rests on the cell connector between the battery cells in a heat-transferring manner. Heat accumulating at or in the cell connector is thus transferred from the cell connector to the heat transfer projection and is dissipated via this in the direction of the temperature control element, in particular to the temperature control element. Conversely, heat can of course also be directed from the temperature control element towards the cell connector in order to heat it up. The heat transfer projection ensures a more even heat distribution or temperature distribution between the cell connector and the battery cells or within the battery cells, thus improving the service life of the traction battery.

A further development of the invention provides that the heat transfer projection is an engagement projection which is arranged between the connection terminals of the battery cells and is encompassed by the cell connector which electrically connects the connection terminals to one another. The engagement projection represents a first variant of the heat transfer projection. The engagement projection originates from the temperature control element and extends between the battery cells in such a way that it is located between the connection terminals. Here, the engagement projection is arranged at a distance from the connection terminals on both sides, so the connection terminals do not touch the engagement projection.

The connection terminals are electrically connected to each other via the cell connector. For this purpose, the cell connector is also present on both sides of the engagement projection and is electrically connected to a first of the battery cells on the one side of the engagement projection and to a second of the battery cells on the other side of the engagement projection. For this purpose, the cell connector encompasses the engagement projection on at least one side. For example, the cell connector is U-shaped in cross-section, i.e. it has two connecting legs which are electrically connected to the connection terminals of the battery cell.

The connecting legs are arranged at a distance from one another, in particular at a parallel distance from one another. Preferably, the connecting legs are located on opposite sides of the engagement projection, thus accommodating it between them. The connecting legs are connected to each other via a connecting leg when viewed in section. For example, the connecting leg is round in section, in particular it is partially circular. In other words, the engagement projection engages the cell connector in order to control the temperature on its side facing away from the battery cells or the connection terminals. This ensures effective removal and/or supply of heat.

A further development of the invention provides that the engagement projection has dimensions in at least one direction, preferably in at least two mutually perpendicular directions, which dimensions at least correspond to the dimensions of the connection terminals in the same direction. The connection terminals have specific dimensions in the direction or in each of the directions mentioned. The dimensions of the engagement projection in the respective direction correspond to these dimensions at least or are even larger. Accordingly, the engagement projection preferably completely overlaps the connection terminals in the direction or directions.

In particular, the engagement projection projects from the temperature control element between the battery cells in such a way that it projects beyond the connection terminals on the side facing away from the temperature control element. Accordingly, the engagement projection projects beyond the connection terminals in at least one direction on opposite sides. This preferably applies to the multiple directions perpendicular to one another. This results in a large effective surface area of the engagement projection available for heat transfer, so that the cell connector is effectively temperature controlled.

A further development of the invention provides that the cell connector defines a cavity into which the engagement projection engages. The cavity is bounded in at least a first direction on opposite sides by the cell connector. In a second direction perpendicular to the first direction, the cavity is preferably delimited on only one side by the cell connector, and in a third direction perpendicular to both the first direction and the second direction, the cavity is open on both sides and is therefore not delimited by the cell connector. For example, the cavity exists between the previously mentioned terminal legs and the connecting leg of the cell connector.

The engagement projection engages in the cavity in such a way that a heat-transferring connection is established between the cell connector and the engagement projection. For example, the engagement projection rests against the cell connector at least in part, preferably over its entire surface. This also ensures effective temperature control of the cell connector.

A further development of the invention provides that the engagement projection is connected to the cell connector in a heat-transferring manner via a heat-conducting medium. The heat conducting medium is arranged between the engagement projection and the cell connector to improve the heat transfer between them. For example, the cavity is at least partially filled with the heat-conducting medium.

A further development of the invention provides that the heat transfer projection is a contact projection which accommodates the cell connector at least in part. The contact projection represents a first variant of the heat transfer projection. The contact projection also extends from the temperature control element into between the battery cells. In contrast to the engagement projection, however, it does not engage with the cell connector, but rather accommodates it in sections. In other words, the contact projection encompasses the cell connector at least in part and rests against it in a heat-transferring manner.

Preferably, the contact projection extends less far between the battery cells than the engagement projection. In particular, the contact projection is spaced from an imaginary plane which passes through both connection terminals, in particular is perpendicular to them. The imaginary plane, for example, intersects the connection terminals on their side facing the temperature control element, from which the contact projection originates. With such a design of the heat transfer projection, good temperature control of the cell connector is also achieved.

A further development of the invention provides that the contact projection has a cell connector receptacle which is delimited by a contact wall against which the cell connector rests in a flat manner in a heat-transferring manner. The cell connector receptacle is provided as a recess in the contact projection. On the one hand, it is limited by the contact wall, on the other hand, it is open or has an opening through which the cell connector engages therein.

The contact wall is designed to form-fit the cell connector. This means that a contour of the contact wall is at least similar to or completely identical to an outer contour of the cell connector on its side facing the contact wall. This ensures that the cell connector fits snugly against the contact wall, ensuring good heat transfer between them. Preferably, the contact wall is round in section, in particular partially circular. Even with such a design of the traction battery, reliable and efficient temperature control of the cell connector is achieved.

A further development of the invention provides that the contact projection has a locking device and is fastened to the cell connector in a form-fitting manner by means of the locking device. The locking device serves to positively fasten the contact projection to the cell connector in order to establish a reliable thermal connection between them. The locking device encompasses the cell connector in at least one direction, in particular in the third direction already mentioned. In particular, the locking device is located on opposite sides of the cell connector and projects form-fittingly into the cell connector on these opposite sides, in particular into the cavity.

The locking device preferably consists of a flexible, in particular elastic, material which enables a locking fastening of the locking device to the cell connector. The locking device can be designed in one piece and made of the same material as the contact projection. However, it can also be made of a different material than the contact projection and subsequently attached to it. In any case, the advantages already mentioned are achieved.

A further development of the invention provides that the contact projection encompasses the cell connector and rests on the connection terminals on opposite sides. It has already been pointed out that the contact projection partially accommodates the cell connector. In doing so, it at least partially encompasses the cell connector. The encompassing takes place in such a way that the contact projection on opposite sides of the cell connector rests on the connection terminals, i.e. it is supported on them. Preferably, this creates a thermal connection between the contact projection and the connection terminals, so that both the cell connector and the connection terminals are directly temperature-controlled or can be temperature-controlled by means of the contact projection. This achieves particularly efficient temperature control.

A further development of the invention provides that the cell module is a first cell module, the battery cell arrangement is a first battery cell arrangement, the temperature control element is a first temperature control element and the temperature control surface is a first temperature control surface and in addition to the first cell module there is a second cell module with a second battery cell arrangement and a second temperature control element, wherein the second temperature control element is arranged on a side of the first battery cell arrangement opposite the first temperature control element and rests with a second temperature control surface in a heat-transfer manner against the first battery cells.

The traction battery has multiple cell modules, namely at least the first cell module and the second cell module. In principle, any number of such cell modules can be present, with two of the cell modules being adjacent to each other, i.e. arranged next to each other. For example, the cell modules are directly adjacent to one another, meaning they are arranged directly next to one another. Each of the cell modules has a battery cell arrangement with multiple battery cells and a temperature control element with a temperature control surface. If the holding frame is provided, each of the cell modules also has such a holding frame that connects the respective battery cell arrangement and the respective temperature control element. It can be provided that the holding frames of the cell modules are designed as a common holding frame, i.e. that the holding frames are manufactured in one piece and/or from the same material. The holding frames can of course also be separate from each other and attached to each other.

The cell modules are preferably designed identically to one another. The multiple cell modules together form the aforementioned battery module; accordingly, they are preferably arranged together between two end plates and clamped together by means of the clamping device. At least one such battery module is arranged in the battery housing of the traction battery.

At least one of the battery cell arrangements of the cell modules is arranged between two temperature control elements of the cell modules, namely between the first temperature control element and the second temperature control element. The battery cell arrangement is thermally coupled on opposite sides with the temperature control elements or their temperature control surfaces, for example using heat conducting mediums. The first temperature control element of the first cell module is thus located on a first side of the battery cell arrangement and the second temperature control element of the second cell module is located on a second side of the battery cell arrangement. The battery cell arrangement is thermally connected to both, preferably with a heat-conducting medium. Such an arrangement enables particularly effective temperature control of the battery cell arrangement or of the multiple battery cell arrangements.

A further development of the invention provides that the heat transfer projection is designed as a first heat transfer projection in the form of the engagement projection and that the temperature control device has, in addition to the first heat transfer projection, a second heat transfer projection in the form of the contact projection. This means that the traction battery or cell module does not have just one heat transfer projection, but multiple heat transfer projections which are designed differently.

The first heat transfer projection is an engagement projection and the second heat transfer projection is a contact projection. The engagement projection and the contact projection engage between the battery cells from opposite sides, namely between the same battery cells. Thus, the engagement projection and the contact projection are also thermally connected to the same cell connector or are in contact with the same cell connector in a heat-transferring manner. In other words, the cell connector is received between the engagement projection and the contact projection, in particular it is held clamped between them. This enables particularly effective temperature control of the cell connector.

A further development of the invention provides that the first heat transfer projection extends from the first temperature control element and the second heat transfer projection extends from the second temperature control element, so that the first heat transfer projection and the second heat transfer projection extend from opposite sides between the battery cells and accommodate the cell connector between them. This has also been already addressed.

The features and feature combinations described in the description, in particular the features and feature combinations described below in the description of the figures and/or shown in the figures may be used not only in the respective specified combination, but also in other combinations or alone, without departing from the scope of the invention, in particular within the scope of the claims. The invention should therefore also be considered to comprise embodiments that are explicitly not shown or explained in the description and/or the figures, but emerge from the explained embodiments or can be derived from them, in particular within the scope of the claims.

### BRIEF DESCRIPTION OF THE FIGURES

In the following, the invention will be explained in greater detail with reference to the exemplary embodiments depicted in the drawing, without this limiting the invention. In particular:

FIG. 1 shows a schematic representation of a region of a traction battery in a longitudinal section, and

FIG. 2 shows a schematic representation of the traction battery in a cross sectional view.

### DETAILED DESCRIPTION

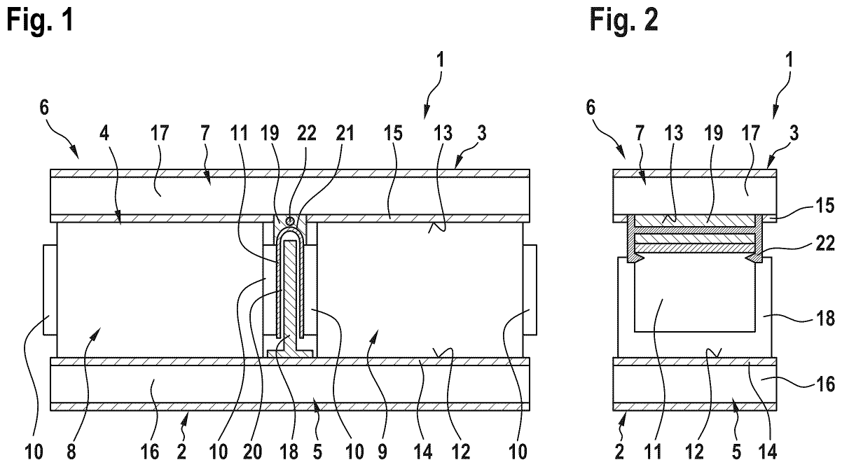

FIG. 1 is a schematic representation of a portion of a traction battery 1 for a motor vehicle in a longitudinal section. The traction battery 1 has a first cell module 2 and a second cell module 3. Of the first cell module 2, a battery cell arrangement 4 and a first temperature control element 5 of a temperature control device 6 are shown here. Of the second cell module 3, only a second temperature control element 7 is shown, which is also part of the temperature control device 6. Preferably, the second cell module 3 has a battery cell arrangement, which is not shown here, however.

The battery cell arrangement 4 has at least a first battery cell 8 and a second battery cell 9. Each of the battery cells 8 and 9 has connection terminals 10, which are provided and designed for the electrical connection of the battery cells 8 and 9 to each other and to connections of the traction battery 1. The battery cells 8 and 9 are arranged at a distance from one another, so that there is a distance between their mutually facing connection terminals 10. For the electrical connection of the battery cells 8 and 9, a cell connector 11 is connected to these connection terminals 10. The cell connector 11 engages on the one hand with the connection terminal 10 of the first battery cell 8 and on the other hand with the connection terminal 10 of the second battery cell 9 and is electrically connected to them.

For temperature control of the battery cells 8 and 9, the cell modules 2 and 3 have the temperature control elements 5 and 7, which are part of the temperature control device 6. Each of the temperature control elements 5 and 7 has a temperature control surface 12 and 13, respectively, which are in contact with both battery cells 8 and 9 of the battery cell arrangement 4 in a heat-transferring manner. The temperature control surfaces 12 and 13 are located, for example, on a jacket 14 and 15 of the respective temperature control element 5 and 7, respectively. Cooling plates 16 and 17 are accommodated in the jackets 14 and 15, respectively. At least one respective fluid channel is formed in each of the cooling plates 16 and 17, which is at least temporarily supplied with a fluid to control the temperature of the battery cell arrangement 4.

A heat transfer projection 18 and 19 respectively extends from each of the temperature control elements 5 and 7. The heat transfer projection 18 is an engagement projection and the heat transfer projection 19 is a contact projection. The meaning of these terms is immediately apparent from the illustration. The engagement projection 18 engages in the cell connector 11, namely in a cavity 20 which is delimited by the cell connector 11. The engagement projection 18 extends between and in the connection terminals 10, in particular it protrudes beyond them on both sides when viewed in section.

The contact projection 19 is arranged outside the cell connector 11. It has a cell connector receptacle 21 which accommodates the cell connector 11 at least in regions. For example, the installation projection 19 extends so far in the direction of the connection terminals 10 that it partially rests against them. This achieves a temperature control of both the cell connector 11 and the connection terminals 10. The contact projection 19 is preferably form-fittingly secured to the cell connector 11 by means of a locking device 22.

FIG. 2 shows a schematic representation of the traction battery 1 in a further sectional view, namely in cross section. It is now clearly visible that the locking device 22 engages form-fittingly from opposite sides into the cell connector 11 or its cavity 20. This ensures a reliable hold of the contact projection 19 on the cell connector 11, so that ultimately the cell connector 11 rests reliably against the contact projection 19 in a heat-transferring manner. This also serves to reliably control the temperature of the battery cell arrangement 4.

### LIST OF REFERENCE NUMERALS

1 traction battery
2 1. cell module
3 2. cell module
4 battery cell arrangement
5 1. temperature control element
6 temperature control device
7 2. temperature control element
8 1. battery cell
9 2. battery cell
10 connection terminal
11 cell connector
12 temperature control surface
13 temperature control surface
14 jacket
15 jacket
16 cooling plate
17 cooling plate
18 heat transfer projection
19 heat transfer projection
20 cavity
21 cell connector receptacle
22 locking device

1. A traction battery for a motor vehicle, with a cell module having a battery cell arrangement and a temperature control device for temperature control of the battery cell arrangement, wherein a cell connector is arranged between each two battery cells of the battery cell arrangement, which cell connector is connected to connection terminals of the battery cells in order to establish an electrical connection between the battery cells, wherein the temperature control device has a temperature control element having at least one fluid channel and having a temperature control surface against which the battery cells rest in a heat-transferring manner, wherein a heat transfer projection extends from the temperature control element, and extends between the battery cells and rests against the cell connector in a heat-transferring manner.

2. The traction battery according to claim 1, wherein the heat transfer projection is an engagement projection arranged between the connection terminals of the battery cells and surrounded by the cell connector electrically connecting the connection terminals to each other.

3. The traction battery according to claim 1, wherein the engagement projection has dimensions in at least one direction which dimensions at least correspond to dimensions of the connection terminals in the same direction.

4. The traction battery according to claim 1, wherein the heat transfer projection is a contact projection which receives the cell connector at least in regions.

5. The traction battery according to claim 1, wherein the contact projection has a cell connector receptacle which is delimited by a contact wall against which the cell connector rests in a manner that allows heat transfer across a large area.

6. The traction battery according to claim 1, wherein the contact projection has a locking device and is fastened to the cell connector in a form-fitting manner by means of the locking device.

7. The traction battery according to claim 1, wherein the contact projection engages around the cell connector and rests on the connection terminals on opposite sides.

8. The traction battery according to claim 1, wherein the cell module is a first cell module, the battery cell arrangement is a first battery cell arrangement with first battery cells, the temperature control element is a first temperature control element and the temperature control surface is a first temperature control surface and in addition to the first cell module there is a second cell module with a second battery cell arrangement and a second temperature control element, wherein the second battery cell arrangement is arranged on a side of the first battery cell arrangement opposite the first temperature control element and rests with a second temperature control surface in a heat-transfer manner on the first battery cells.

9. The traction battery according to claim 1, wherein the heat transfer projection is designed as a first heat transfer projection in the form of the engagement projection, and the temperature control device comprises a second heat transfer projection in the form of the contact projection in addition to the first heat transfer projection.

10. The traction battery according to claim 1, wherein the first heat transfer projection extends from the first temperature control element and the second heat transfer projection extends from the second temperature control element, so that the first heat transfer projection and the second heat transfer projection extend from opposite sides between the battery cells and accommodate the cell connector between them.

11. The traction battery according to claim 2, wherein the engagement projection has dimensions in at least one direction which dimensions at least correspond to dimensions of the connection terminals in the same direction.

12. The traction battery according to claim 2, wherein the heat transfer projection is a contact projection which receives the cell connector at least in regions.

13. The traction battery according to claim 3, wherein the heat transfer projection is a contact projection which receives the cell connector at least in regions.

14. The traction battery according to claim 2, wherein the contact projection has a cell connector receptacle which is delimited by a contact wall against which the cell connector rests in a manner that allows heat transfer across a large area.

15. The traction battery according to claim 3, wherein the contact projection has a cell connector receptacle which is delimited by a contact wall against which the cell connector rests in a manner that allows heat transfer across a large area.

16. The traction battery according to claim 4, wherein the contact projection has a cell connector receptacle which is delimited by a contact wall against which the cell connector rests in a manner that allows heat transfer across a large area.

17. The traction battery according to claim 2, wherein the contact projection has a locking device and is fastened to the cell connector in a form-fitting manner by means of the locking device.

18. The traction battery according to claim 3, wherein the contact projection has a locking device and is fastened to the cell connector in a form-fitting manner by means of the locking device.

19. The traction battery according to claim 4, wherein the contact projection has a locking device and is fastened to the cell connector in a form-fitting manner by means of the locking device.

20. The traction battery according to claim 5, wherein the contact projection has a locking device and is fastened to the cell connector in a form-fitting manner by means of the locking device.
